(19) United States
(12) Patent Application Publication
(10) Pub. No.: US 2013/0183912 A1
(43) Pub. Date: Jul. 18, 2013

(54) BASEBAND STRUCTURE OF TRANSCEIVER

(71) Applicants: Duong Quoc Hoang, Daejeon (KR); Cheon Soo KIM, Daejeon (KR); Pil Jae PARK, Daejeon (KR); Min PARK, Daejeon (KR); Hyun Kyu YU, Daejeon (KR)

(72) Inventors: Duong Quoc Hoang, Daejeon (KR); Cheon Soo KIM, Daejeon (KR); Pil Jae PARK, Daejeon (KR); Min PARK, Daejeon (KR); Hyun Kyu YU, Daejeon (KR)

(73) Assignee: Electronics and Telecommunications Research Institute, Daejeon (KR)

(21) Appl. No.: 13/552,397

(22) Filed: Jul. 18, 2012

(30) Foreign Application Priority Data
Jul. 18, 2011 (KR) 10-2011-0071199
Jul. 17, 2012 (KR) 10-2012-0077970

(51) Int. Cl. H04B 1/38

(52) U.S. Cl. CPC H04B 1/38
USPC 455/79

(57) ABSTRACT

There is provided a baseband structure of a transceiver. In an embodiment, a baseband structure of a transceiver includes a Variable Gain Amplifier (VGA) configured to amplify an input signal by controlling a gain, one or more Fixed Gain Amplifiers (FGAs) connected in series to the VGA and configured to amplify an output signal of the VGA, and one or more selection switches configured to selectively operate the FGAs. In accordance with the present invention, since a plurality of FGAs is selectively driven according to a necessary gain and an LPFG includes an FGA, power consumption and the size of a chip can be reduced and the overall performance of a transceiver can be improved.

### CROSS-REFERENCES TO RELATED APPLICATIONS

The present application claims priority under 35 U.S.C 119(a) to Korean Application Nos. 10-2011-0071199, filed on Jul. 18, 2011 and 10-2012-0077970, filed on Jul. 17, 2012 in the Korean Intellectual Property Office, which are incorporated herein by reference in their entirety set forth in full.

### BACKGROUND

Exemplary embodiments of the present invention relate to baseband structures of a transceiver, and more particularly, to baseband structures of a transceiver which are capable of reducing power consumption and the size of a chip by selectively operating fixed gain amplifiers according to a necessary gain.

In recent years, the use of a direct conversion transceiver has begun to replace the use of a heterodyne transceiver in various types of wireless applications.

The direct conversion receiver converts a received Radio Frequency (RF) signal into a baseband frequency directly without an Intermediate Frequency (IF).

From a viewpoint of this direction conversion, lots of application communications, such as Global System for Mobile communications (GSM), Bluetooth, Code Division Multiple Access (CDMA), Zigbee, Ultra Wide Band (UWB), and automotive radar, have been developed.

In the direct conversion transceiver, the size of an RF I/O signal may be greatly changed, and noise may be intruded inside and outside the transceiver. For this reason, the direct conversion transceiver requires the baseband structure including lots of Low Pass Filters (LPFs) and Variable Gain Amplifiers (VGAs), in order to cover a wide variation range of RF I/O signals and suppress unwanted signals.

FIG. 1 is a diagram illustrating the baseband structure of a transceiver used in various wireless application communications, and FIG. 2 is a graph illustrating that the gains of the baseband structure of a transceiver shown in FIG. 1 are represented by a function of control bits.

As shown in FIG. 1(a), the conventional baseband structure of a transceiver includes a plurality of VGAs VGA₁, . . . , VGAₙ, a plurality of LPFs LPF₁, . . . , LPFₖ, and a DC-Offset Cancellation (DCOC) circuit.

The conventional baseband structure of a transceiver has issues regarding power consumption and the size of a chip because it includes a large number of VGAs and LPFs as described above. Especially, in some application fields, such as automotive radar, power consumption and the size of a chip becomes critical issues because one completed product may include a lot of receivers.

Furthermore, a larger chip size is required because each of the digitally-controlled VGAs VGA₁, . . . , VGAₙ includes a large number of switches and resistors to control a gain as shown in FIG. 1(b).

The gain of the baseband structure of a transceiver shown in FIG. 1 is controlled by N control bits. The number N of control bits is determined depending on the required resolution of step gains.

Assuming that one VGA has a gain control range from −A dB to A dB, if n VGAs VGA₁, . . . , VGAₙ are used, the baseband structure of a transceiver may have a gain control range from −nA dB to nA dB as shown in FIG. 2.

Here, an actual gain variation range can be shifted upwards or downwards because each of the VGAs is designed with a gain offset.

### SUMMARY

An embodiment of the present invention relates to a baseband structure of a transceiver which is capable of reducing power consumption and the size of a chip by selectively operating fixed gain amplifiers according to a necessary gain.

In one embodiment, a baseband structure of a transceiver includes a Variable Gain Amplifier (VGA) configured to amplify an input signal by controlling a gain, one or more Fixed Gain Amplifiers (FGAs) connected in series to the VGA and configured to amplify the output signal of the VGA, and one or more selection switches configured to selectively operate the FGAs.

In the present invention, the selection switches select the operation of the FGAs according to a necessary gain.

In the present invention, the selection switches sequentially select the FGAs.

In the present invention, the selection switches are connected in parallel to the FGAs.

The baseband structure further includes one or more power switches configured to supply or block power to the FGAs.

In the present invention, when the selection switch is turned on, the power switch blocks the power.

In the present invention, the selection switch is inserted between an input terminal and an output terminal of the FGA to isolate the FGA from the baseband structure when the selection switch is turned on.

The baseband structure further includes one or more Low Pass Filters integrated with Fixed Gain Amplifiers (LPFGs) connected in series to the VGA and the FGAs and configured to perform filtering according to a necessary bandwidth.

In the present invention, the LPFGs are operated in a high-gain mode or a low-gain mode.

In the present invention, the LPFGs are switched from the low-gain mode to the high-gain mode according to a necessary gain.

In the present invention, the VGA, the FGAs and the LPFGs are arranged in order.

In the present invention, some of the LPFGs, the VGA, the FGAs and the others of the LPFGs are arranged in order.

In the present invention, the LPFGs, the VGA and the FGAs are arranged in order.

The baseband structure further includes one or more DC-Offset Cancellation (DCOC) circuits for cancelling DC offset voltage of the output signal of the VGA and the FGAs.

### BRIEF DESCRIPTION OF THE DRAWINGS

The above and other aspects, features and other advantages will be more clearly understood from the following detailed description taken in conjunction with the accompanying drawings, in which:

FIG. 1 is a diagram illustrating the baseband structure of a transceiver used in various wireless application communications;

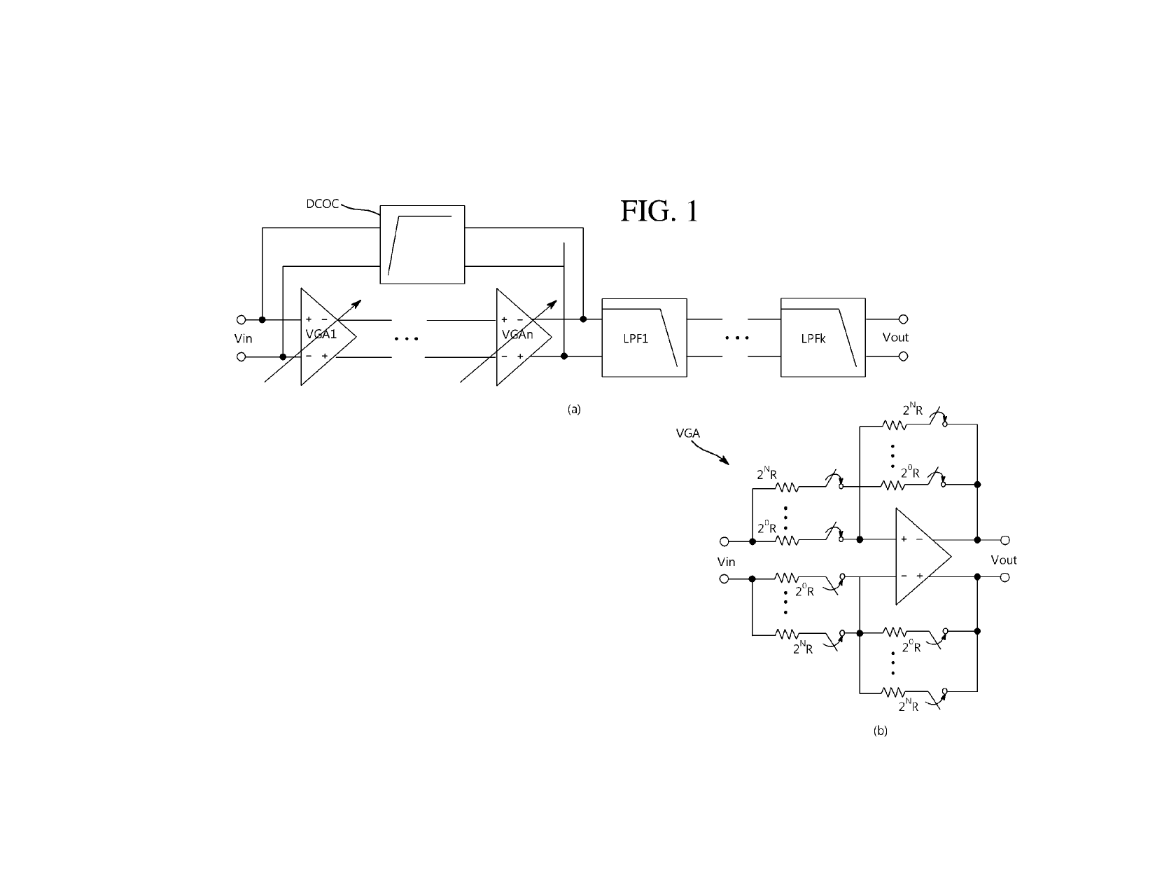

FIG. 2 is a graph illustrating that the gains of the baseband structure of a transceiver shown in FIG. 1 are represented by a function of control bits;

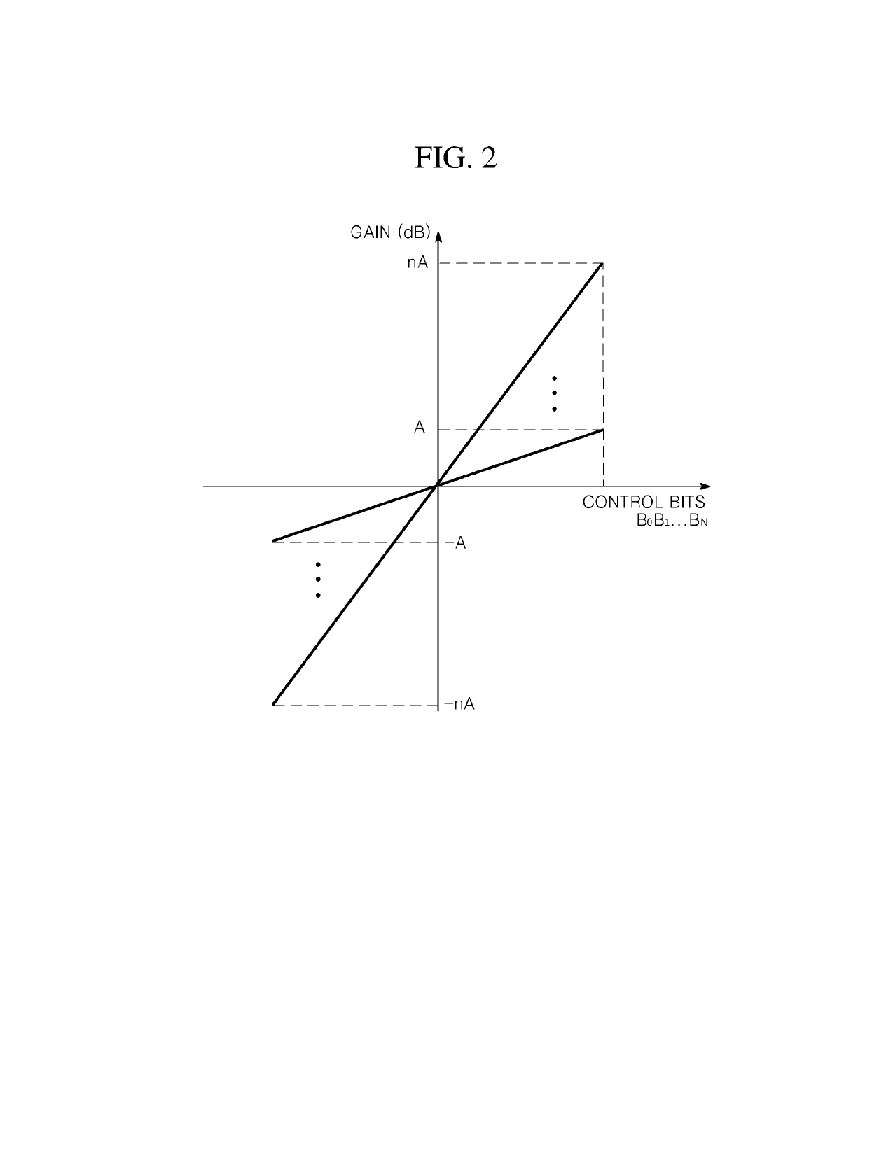

FIG. 3 is a circuit diagram illustrating a baseband structure of a transceiver in accordance with a first embodiment of the present invention;

FIG. 4 is a circuit diagram illustrating a VGA and an FGA in the baseband structure of a transceiver in accordance with the first embodiment of the present invention;

FIG. 5 is a circuit diagram of an LPFG in the baseband structure of a transceiver in accordance with the first embodiment of the present invention;

FIG. 6 is a graph illustrating that the gains of the baseband structure of a transceiver in accordance with the first embodiment of the present invention are represented by a function of control bits;

FIG. 7 is a circuit diagram illustrating a baseband structure of a transceiver in accordance with a second embodiment of the present invention;

FIG. 8 is a circuit diagram illustrating another embodiment of the baseband structure of a transceiver in accordance with the second embodiment of the present invention; and

FIG. 9 is a circuit diagram illustrating a baseband structure of a transceiver in accordance with a third embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

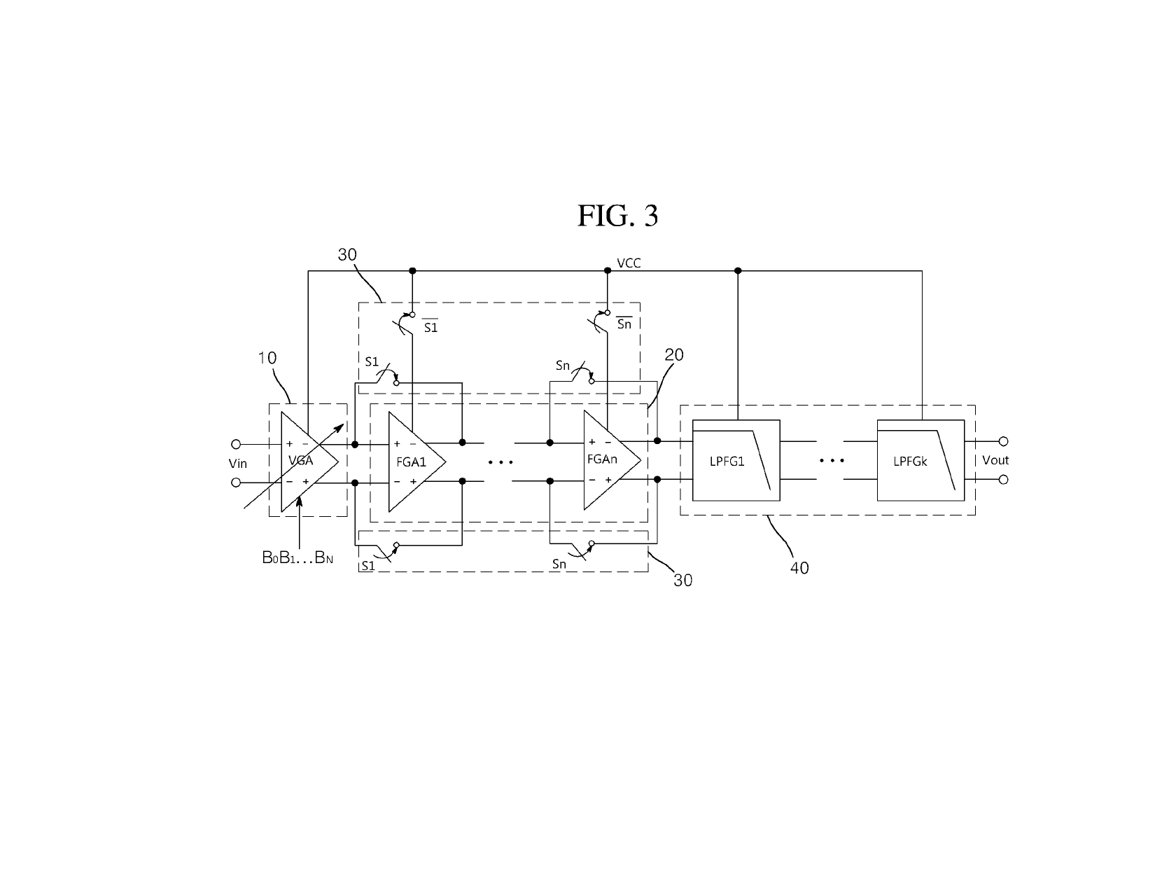

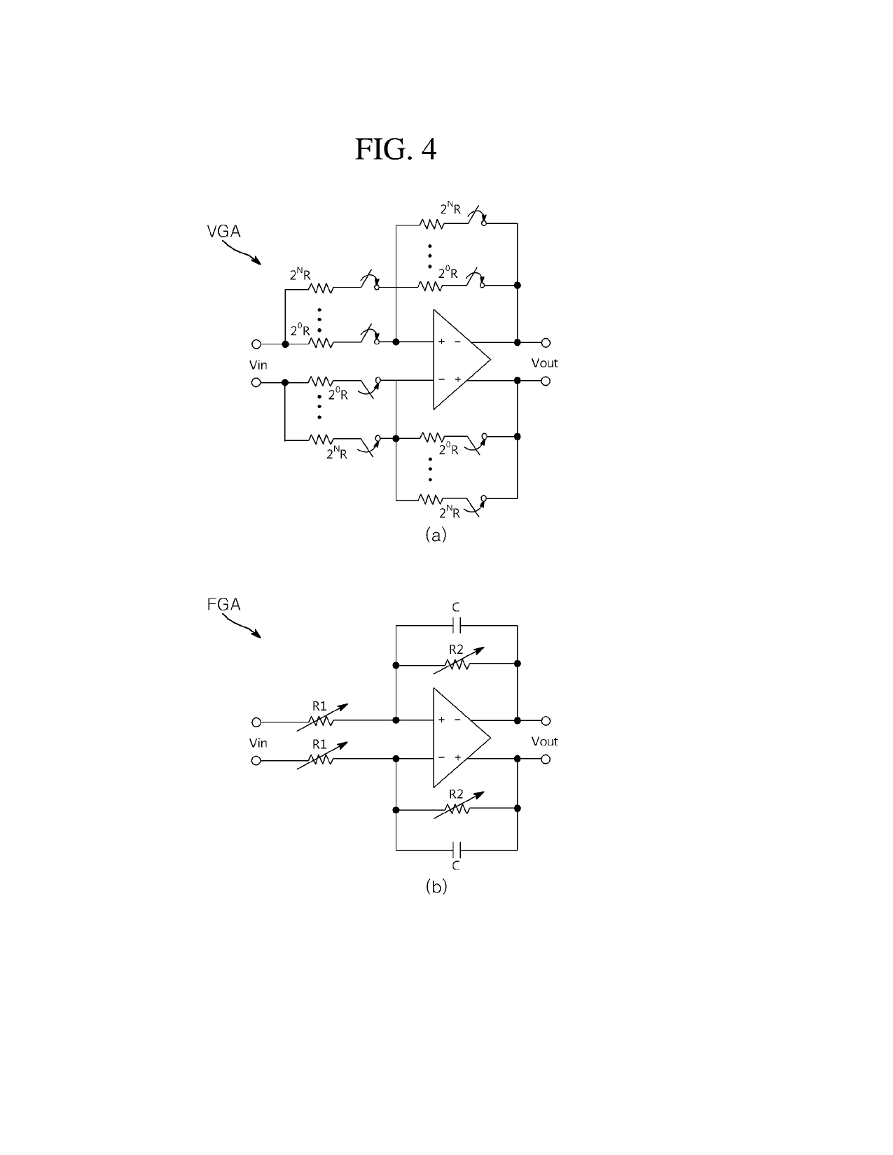

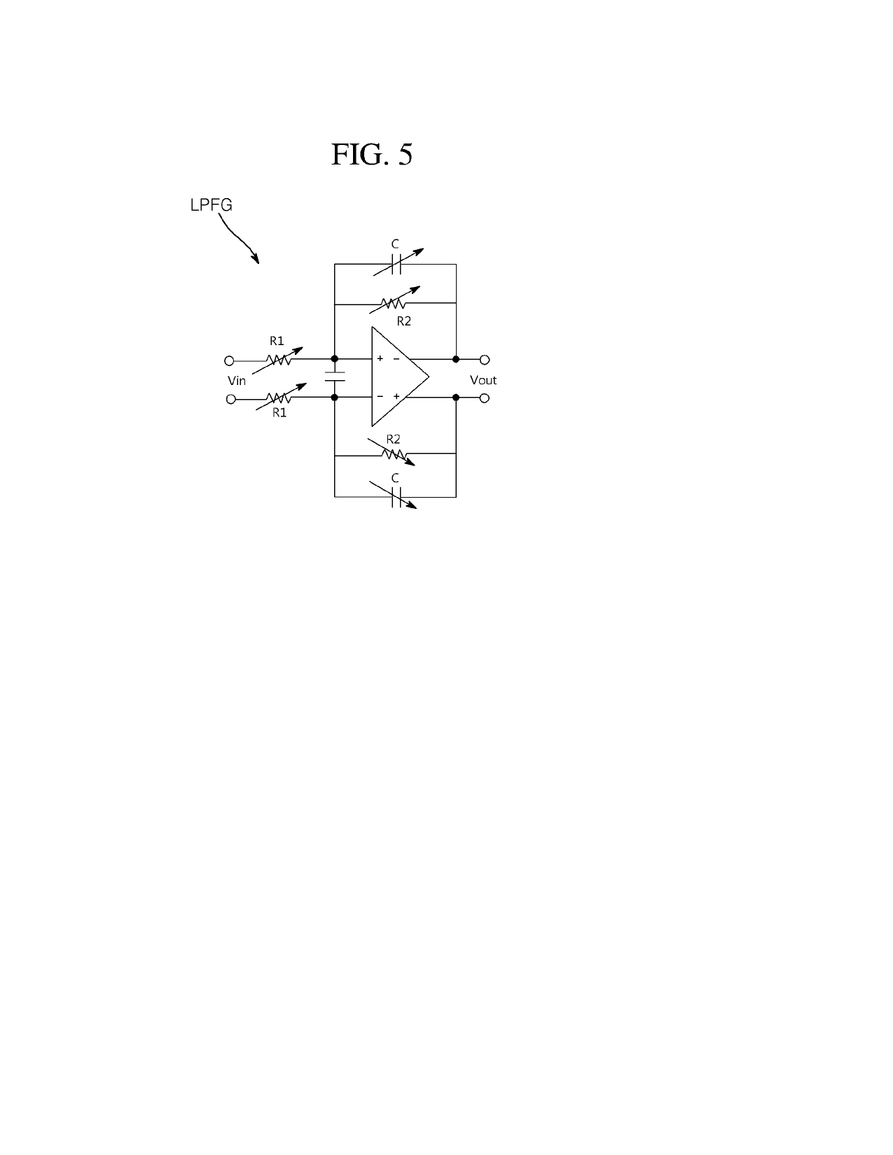

FIG. 3 is a circuit diagram illustrating a baseband structure of a transceiver in accordance with a first embodiment of the present invention, FIG. 4 is a circuit diagram illustrating a VGA and an FGA in the baseband structure of a transceiver in accordance with the first embodiment of the present invention, and FIG. 5 is a circuit diagram of an LPFG in the baseband structure of a transceiver in accordance with the first embodiment of the present invention.

As shown in FIG. 3, the baseband structure of a transceiver in accordance with the first embodiment of the present invention includes a Variable Gain Amplifier (VGA) unit 10, a Fixed Gain Amplifier (FGA) unit 20, a switch unit 30, and a Low Pass Filter (LPF) unit 40.

The VGA unit 10 amplifies an input signal Vᵢₙ by varying a gain and provides a proper gain to a baseband system.

As shown in FIG. 3, the VGA unit 10 may include one VGA that provides a gain ranging from −A dB to A dB. As shown in FIG. 4(a), the VGA includes a lot of resistors. The gain variation range of the VGA can be varied by a gain offset.

The VGA operates in an ON state basically and uses N control bits B₀˜B_{N} to control the gain.

The FGA unit 20 is connected in series to the VGA unit 10 and is configured to amplify the output signal of the VGA unit 10 and provide an additional gain to the baseband system.

As shown in FIG. 3, the FGA unit 20 may include one or more FGAs FGA₁, . . . , FGAₙ consecutively connected in series. The FGAs FGA₁, . . . , FGAₙ may provide respective gains ranging from −2 A dB to 0 dB or 0 dB to 2 A dB.

As shown in FIG. 4(b), each of the FGAs includes resistors and capacitors. In accordance with the present invention, the size of a chip can be reduced by replacing a large number of the existing VGAs with the FGAs.

The switch unit 30 includes one or more selection switches S₁, . . . , S_{N} for selectively operating the FGAs FGA₁, . . . , FGAₙ and one or more power switches S̅₁̅, . . . , S̅_̅{̅N̅}̅ for supplying or blocking power to the FGAs FGA₁, . . . , FGAₙ.

That is, the FGAs FGA₁, . . . , FGAₙ may be controlled by the selection switches S₁, . . . , S_{N} and the power switches S̅₁̅, . . . , S̅_̅{̅N̅}̅, respectively.

As shown in FIG. 3, the plurality of selection switches S₁, . . . , S_{N} are connected in parallel to the respective FGAs FGA₁, . . . , FGAₙ and are configured to selectively operate the FGAs FGA₁, . . . , FGAₙ.

Particularly, when the selection switch S is turned on, the input terminal and output terminal of the FGA are shorted, and thus an input signal bypasses the FGA. At this time, the power switch S is turned off, and thus power supplied to the FGA is blocked, and the FGA is isolated from the baseband structure.

Next, when the selection switch S is turned off, the power switch S̅ is turned on and thus power is supplied to the FGA.

As described above, in accordance with the present invention, a proper number of the FGAs may be selectively operated according to a necessary gain, and unnecessary FGAs may not be operated when a necessary gain is small. Accordingly, power consumption can be reduced.

Meanwhile, in order to control the operations of the plurality of selection switches S₁, . . . , S_{N} and the power switches S̅₁̅, . . . , S̅_̅{̅N̅}̅, more control bits from B_{N+1} may be used.

The LPF unit 40 is connected in series the VGA unit 10 and the FGA unit 20 and is configured to supply a necessary bandwidth and an additional gain to the baseband system.

The LPF unit 40 may include one or more Low Pass Filter integrated with Fixed Gain Amplifiers (LPFGs) including an FGA and having a gain control function.

That is, as shown in FIG. 3, the LPF unit 40 may include one or more LPFGs LPFG₁, . . . , LPFGₖ connected in series to the VGA unit 10 and the FGA unit 20 and configured to provide a necessary bandwidth and an additional gain.

The number of LPFGs included in the LPF unit 40 may be determined depending on the order of a filter. For example, if a 5^{th} order filter and an 8^{th} order filter are necessary, the LPF unit 40 may include three and four LPFGs, respectively.

As shown in FIG. 5, each of the LPFGs LPFG₁, . . . , LPFGₖ is controlled between a low-gain mode and a high-gain mode by resistors and capacitors.

The low-gain mode may be a no-gain mode in which no gain is provided, and the high-gain mode may be a mode in which a gain ranging from −2 A dB to 0 dB or 0 dB to 2 A dB is provided.

As described above, since a gain is controlled between only two modes, an additional gain can be provided while maintaining the performance of a filter, such as a bandwidth and a Q factor, without change by properly controlling the resistors and the capacitors.

Meanwhile, in the present embodiment, each LPFG is illustrated as including an FGA and having a gain control function. In some embodiments, however, only some of the LPFGs may be configured to have the gain control functions or all the LPFGs may be configured not to have the gain control function.

The VGA, the FGAs and the LPFGs may be placed flexibly. The VGA, the FGAs and the LPFGs may be arranged in order. The LPFGs may be placed before the VGA, or may be placed after the FGAs. Also, Some of the LPFGs may be placed before the VGA and the others of the LPFGs may be placed after FGAs

Although not illustrated in FIG. 3, the baseband structure of a transceiver in accordance with an embodiment of the present invention may include one or more DCOC circuits for cancelling the DC offsets of the output signals of the VGAs, the FGAs, and the LPFGs.

In general, a baseband system requires DCOC circuits because it requires a high gain to process an RF signal of a wide and dynamic range. The number of DCOC circuits may be determined by the specifications of a baseband system, such as a gain at a DC frequency, a low-end bandwidth, a cut-off frequency, and noise characteristics.

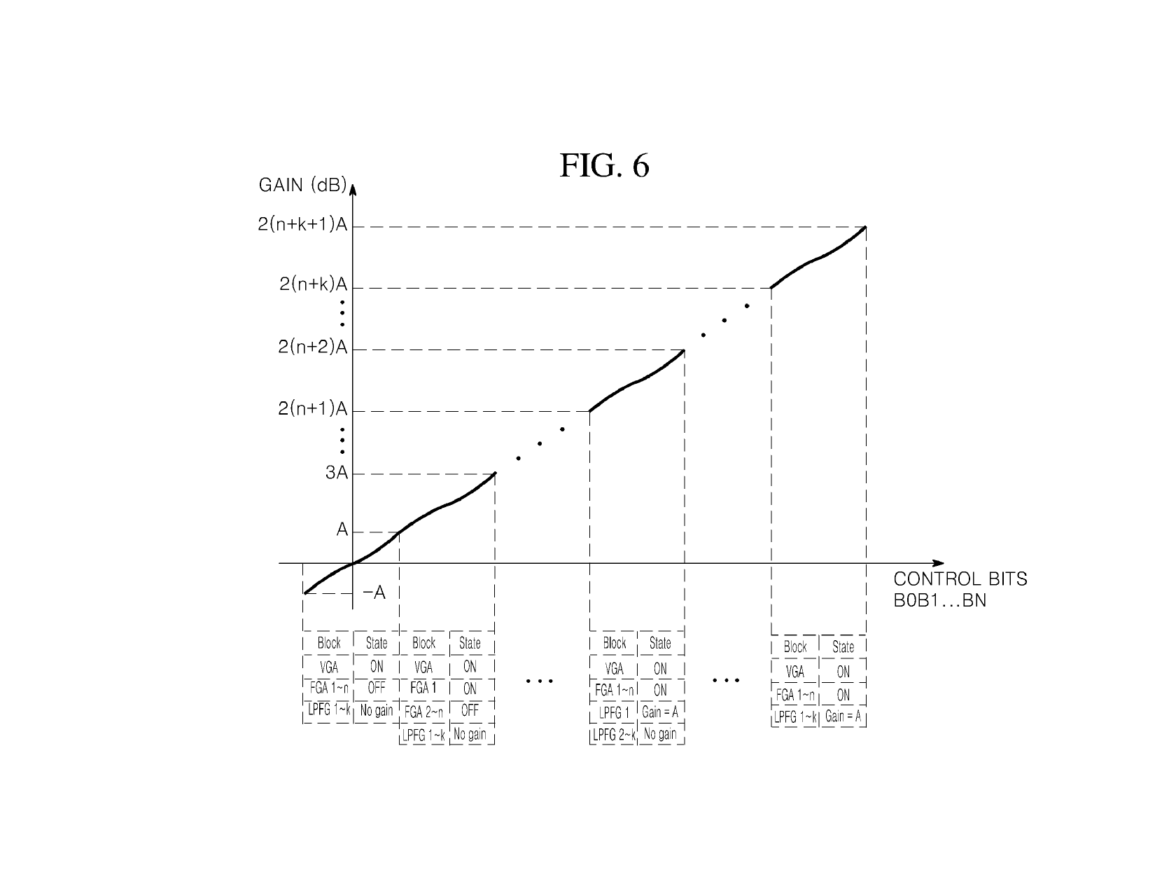

FIG. 6 is a graph illustrating that the gains of the baseband structure of a transceiver in accordance with the first embodiment of the present invention are represented by a function of the control bits. A change of the total gain of the baseband structure of a transceiver configured as in FIG. 3 is illustrated in FIG. 6.

When the VGA has a gain variation range from −A dB to A dB, the gain of each of the FGA and the LPFG is varied between −2 A dB to 0 dB or 0 dB to 2 A dB.

If the number of FGAs is n and the number of LPFGs is k, the baseband structure of a transceiver may provide a gain ranging from −A dB to 2(n+k+1)A dB.

Referring to FIG. 6, in the gain variation range of −A dB to A dB, the VGA is in an ON state, all the FGAs FGA₁, . . . , FGAₙ are in an OFF state, and all the LPFGs LPFG₁, . . . , LPFGₖ are operated in the no-gain mode.

If a necessary gain increases from A dB to 3 A dB, the first selection switch S₁ is turned off and the first power switch S̅₁̅ is turned on, so that the first FGA FGA₁ is operated.

That is, the VGA and the first FGA FGA₁ are in an ON state, the remaining FGAs FGA₂, . . . , FGAₙ are in an OFF state, and all the LPFGs LPFG₁, . . . , LPFGₖ are operated in the no-gain mode.

As described above, the FGAs FGA₁, . . . , FGAₙ sequentially switch to an ON state according to an increase of a necessary gain for a baseband system. If an additional gain is necessary although all the FGAs are in an ON state, the LPFGs LPFG₁, . . . , LPFGₖ are sequentially operated in the high-gain mode.

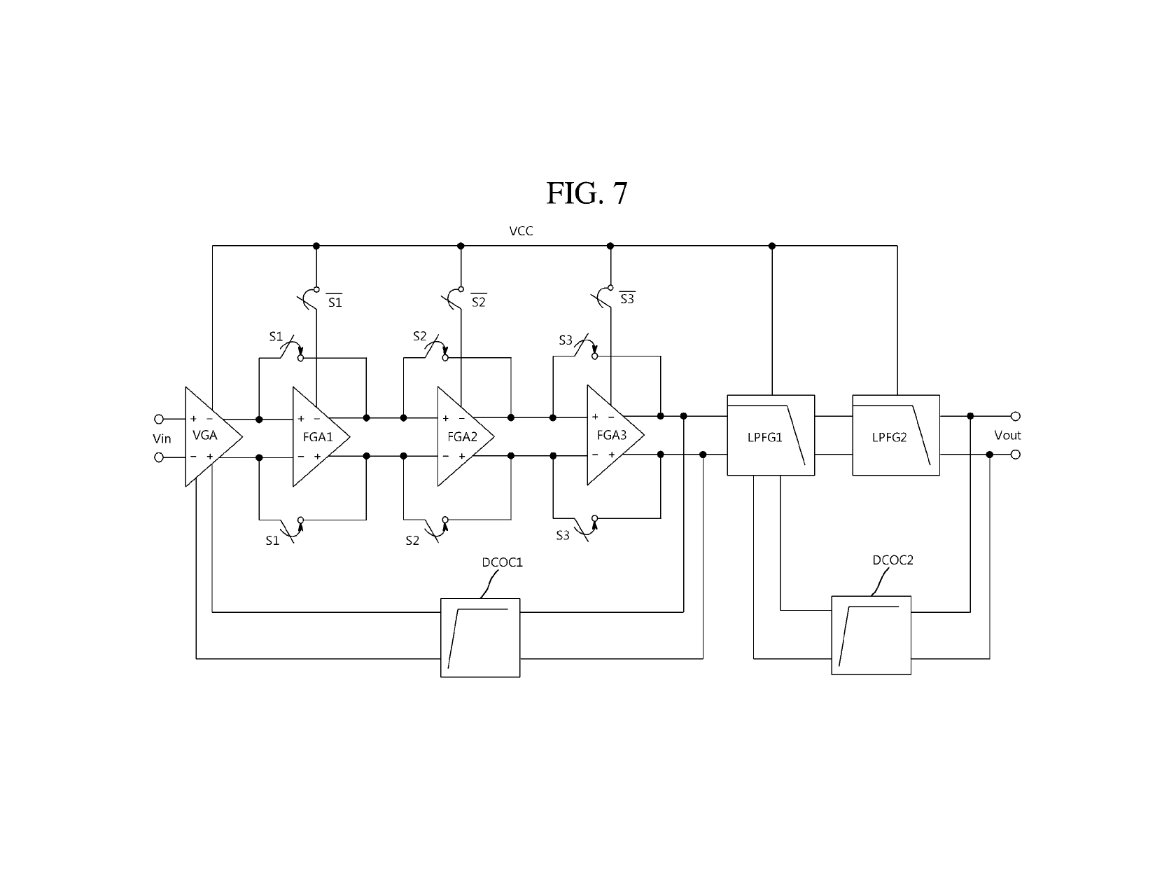

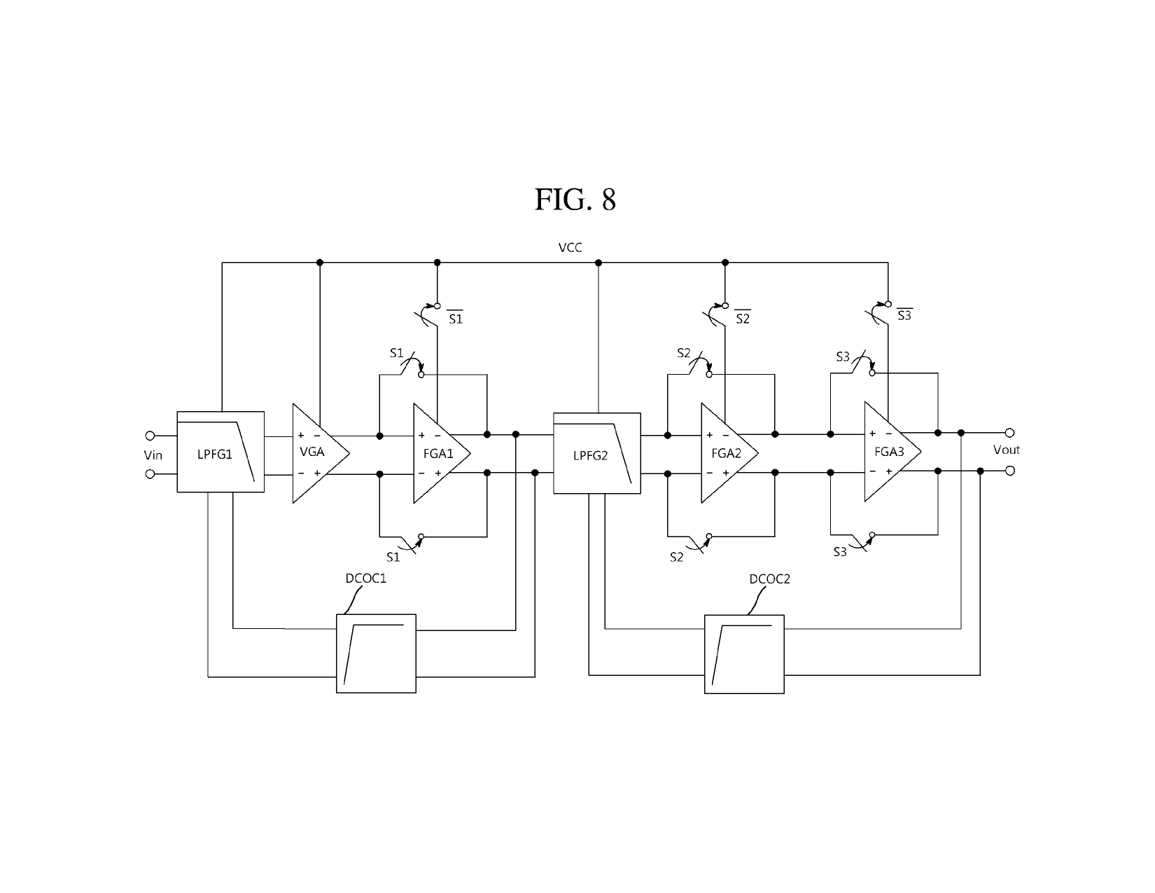

FIG. 7 is a circuit diagram illustrating a baseband structure of a transceiver in accordance with a second embodiment of the present invention, and FIG. 8 is a circuit diagram illustrating another embodiment of the baseband structure of a transceiver in accordance with the second embodiment of the present invention. FIGS. 7 and 8 illustrate the baseband structure of a transceiver that provides a gain variation range of 90 dB and 4^{th} order filtering.

As shown in FIG. 7, the baseband structure of a transceiver in accordance with the second embodiment of the present invention may include one VGA, three FGAs FGA₁, FGA₂, and FGA₃ and two LPFGs LFPG₁ and LPFG₂ all of which are sequentially connected in series.

In the baseband structure of FIG. 7, one of two DCOC circuits DCOC₁ and DCOC₂ is used for the VGA and the FGAs FGA₁, FGA₂, and FGA₃, and the other thereof is used for the LPFGs LPFG₁ and LPFG₂.

Meanwhile, as shown in FIG. 8, the baseband structure of a transceiver in accordance with the second embodiment of the present invention may be configured so that one of the two LPFGs LPFG₁ and LPFG₂ is connected to the front end of the VGA and the other thereof is connected between the three FGAs FGA₁, FGA₂, and FGA₃.

In the baseband structure of FIG. 8, one of the two DCOC circuits DCOC₁ and DCOC₂ may be used for the LPFG LPFG₁, the VGA, and the FGA FGA₁, and the other thereof may be used for the LPFG LPFG₂ and the remaining FGAs FGA₂ and FGA₃.

The VGA provides a gain variation range of −15 dB to 15 dB which has a linearity error less than ±0.5 dB. The FGAs FGA₁, FGA₂, and FGA₃ of an ON state and the LPFGs LPFG₁ and LPFG₂ of the high-gain mode provide a gain of 0 dB to 15 dB or −15 to 0 dB.

Accordingly, each of the baseband structures of a transceiver shown in FIGS. 7 and 8 may provide a gain variation range of 90 dB, and it may be used in application communications, such as GSM, Bluetooth, CDMA, Zigbee and UWB.

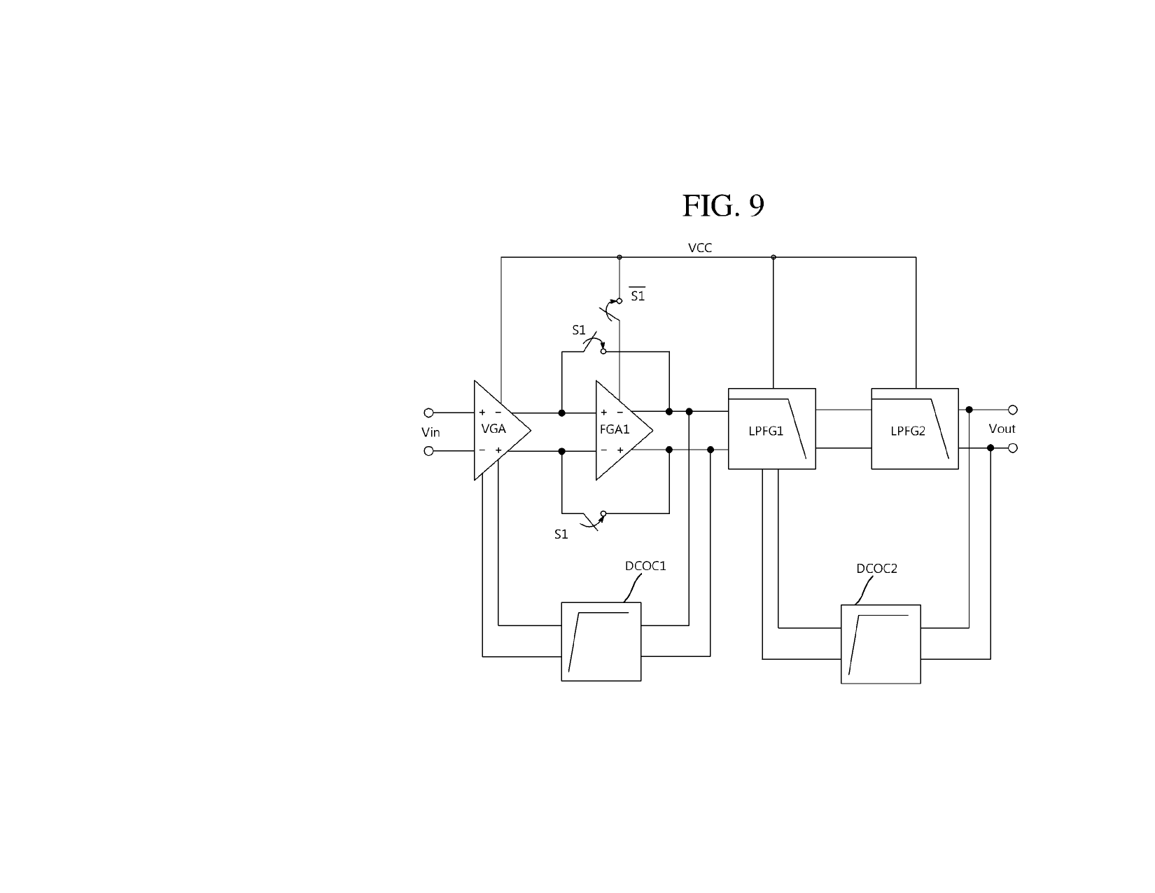

FIG. 9 is a circuit diagram illustrating a baseband structure of a transceiver in accordance with a third embodiment of the present invention. FIG. 9 illustrates the baseband structure of a transceiver which provides a gain variation range of 60 dB and 4^{th} order filtering.

As shown in FIG. 9, the baseband structure of a transceiver in accordance with the third embodiment of the present invention may include one VGA, one FGA FGA₁, and two LPFGs LFPG₁ and LPFG₂ all of which are sequentially connected in series.

In this baseband structure, one of two DCOC circuits DCOC₁ and DCOC₂ may be used for the VGA and the FGA FGA₁, and the other thereof may be used for the LPFGs LPFG₁ and LPFG₂.

As described above, the VGA provides a gain variation range of −15 dB to 15 dB which has a linearity error less than ±0.5 dB. The FGA FGA₁ of an ON state and the LPFGs LPFG₁ and LPFG₂ of the high-gain mode provide a gain of 0 dB to 15 dB or −15 to 0 dB.

Accordingly, the baseband structure of a transceiver shown in FIG. 9 may provide a gain variation range of 60 dB, and it may be used in application communications, such as automotive radar and UWB.

As described above, in accordance with the baseband structures of a transceiver according to the present invention, the size of a chip can be reduced by replacing a large number of VGAs with an FGA or FGAs, and power consumption can be reduced by selectively operating a plurality of FGAs according to a necessary gain.

Furthermore, since the LPFG includes an FGA, power consumption and the size of a chip can be further reduced, and an additional gain can be provided to a baseband system while maintaining the performance of a filter.

The overall performance of a transceiver can be improved because power consumption and the size of a chip are reduced as described above.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A baseband structure of a transceiver, comprising:
a Variable Gain Amplifier (VGA) configured to amplify an input signal by controlling a gain;
one or more Fixed Gain Amplifiers (FGAs) connected in series to the VGA and configured to amplify an output signal of the VGA; and
one or more selection switches configured to selectively operate the FGAs.

2. The baseband structure of claim 1, wherein the selection switches select the operation of the FGAs according to a necessary gain.

3. The baseband structure of claim 2, wherein the selection switches sequentially select the FGAs.

4. The baseband structure of claim 1, wherein the selection switches are connected in parallel to the FGAs.

5. The baseband structure of claim 4, further comprising one or more power switches configured to supply or block power to the FGAs.

6. The baseband structure of claim 5, wherein when the selection switch is turned on, the power switch blocks the power.

7. The baseband structure of claim 6, wherein the selection switch is inserted between an input terminal and an output terminal of the FGA to isolate the FGA from the baseband structure when the selection switch is turned on.

8. The baseband structure of claim 1, further comprising one or more Low Pass Filters integrated with Fixed Gain Amplifiers (LPFGs) connected in series to the VGA and the FGAs and configured to perform filtering according to a necessary bandwidth.

9. The baseband structure of claim 8, wherein the LPFGs are operated in a high-gain mode or a low-gain mode.

10. The baseband structure of claim 9, wherein the LPFGs are switched from the low-gain mode to the high-gain mode according to a necessary gain.

11. The baseband structure of claim 8, wherein the VGA, the FGAs and the LPFGs are arranged in order.

12. The baseband structure of claim 8, wherein some of the LPFGs, the VGA, the FGAs and the others of the LPFGs are arranged in order.

13. The baseband structure of claim 8, wherein the LPFGs, the VGA, the FGAs are arranged in order.

14. The baseband structure of claim 1, further comprising one or more DC-Offset Cancellation (DCOC) circuits for cancelling DC offset voltage of the output signal of the VGA and the FGAs.
